(19) United States
(12) Patent Application Publication
(10) Pub. No.: US 2021/0162787 A1
(43) Pub. Date: Jun. 3, 2021

(54) DEVICE FOR DRIVING A STAMPING FOIL, STAMPING STATION AND MACHINE, AND METHOD FOR CONTROLLING THE DRIVING OF A STAMPING FOIL

(71) Applicant: BOBST MEX SA, Mex (CH)

(72) Inventors: Bernard JAQUET, Rue (CH); Christophe DE GAILLANDE, Les Monts-de-Corsier (CH); Haoming SONG, Shanghai (CN)

(73) Assignee: BOBST MEX SA, Mex (CH)

(21) Appl. No.: 17/045,729

(22) PCT Filed: Apr. 20, 2018
(86) PCT No.: PCT/CN2018/083835

§ 371 Date: Oct. 6, 2020

(51) Int. Cl. B41K 3/64; B41F 19/06; B41K 3/32

(52) U.S. Cl. CPC B41K 3/64; B41K 3/32; B41F 19/068

(57) ABSTRACT

The invention relates to a device (410; 410′) for driving a stamping foil over a path through a stamping machine, the driving device (410; 410′) comprising two foil-introduction chain-like elements (420a, 420b) and a drive member (440) coupled to the foil-introduction chain-like elements (420a, 420b) for driving the foil-introduction chain-like elements (420a, 420b) notably through a platen press (310) of the stamping machine (1), characterized in that it further comprises at least one first load-measurement device (3a; 3a′) comprising a first detector (7a) configured to measure a parameter indicative of the load applied by the drive member (440) for driving the foil-introduction chain-like elements (420a, 420b) in a first direction, the at least one first load-measurement device (3a; 3a′) being connected to a stamping-machine (1) control unit (4) configured to stop the driving by the drive member (440) when the parameter indicative of the load applied by the drive member (440) and measured by the first detector (7a) crosses a threshold.

The present invention also relates to a stamping station and machine comprising the driving device. The present invention also relates to a method for controlling the driving of a stamping foil.

The present invention relates to a device for driving a stamping foil in a machine capable of printing, by stamping, a succession of flat sheet-form elements, notably for the manufacture of packagings. The present invention also relates to a stamping station and machine comprising the driving device. The present invention also relates to a method for controlling the driving of a stamping foil.

Printing text and/or patterns by stamping, namely by using pressure to apply coloured or metallized film from one or more stamping foils to a sheet-form support is known. In industry, such a transfer operation is usually performed using a platen press, into which the print supports are introduced sheet by sheet, whereas each stamping foil is conveyed continuously or step-by-step.

In a standard platen press, stamping takes place between a fixed platen lying horizontally and a platen mounted with the ability to move in a reciprocating vertical movement. Because this type of press is generally automated, transport means are provided for conveying each sheet in turn between the platens. In practice, it is usually a series of bars which each in turn take hold of a sheet along its frontal edge before pulling it between the two platens of the press when the latter are parted sufficiently.

Just like the sheet feeding, the stamping foil feeding of the press is traditionally automated, in this instance by means of a driving system capable of unwinding and conveying the foils along a clearly determined path which notably passes through the platen press.

A foil driving system of this kind comprises a drive bar for introducing the stamping foil into the machine, the bar itself being driven by two foil-insertion chain-like elements which are closed in a loop. The drive bar pulls and unwinds the foil along the path, passing through the press, the foil then being driven by drive rolls belonging to the machine.

Given that the driving system needs to pull and guide the stamping foil through the platen press and that the space between the parted platens is very small, the drive bar and the chain-like elements that drive it need to be very small in thickness and are therefore relatively fragile. If the driving system becomes jammed, for example because of a foil blockage caused by poor unwinding of the foil or the like, the drive bar or the bar attachment may easily break. The machine then has to be stopped to allow the bar to be replaced and then the operator has to reintroduce the stamping foil, partly by hand, which is a lengthy and expensive process.

It is one of the objects of the present invention to propose a stamping-foil driving device in which the risks of breakage are lower.

To this end, one subject of the present invention is a device for driving a stamping foil over a path through a stamping machine, the driving device comprising two foil-introduction chain-like elements and a drive member coupled to the foil-introduction chain-like elements for driving the foil-introduction chain-like elements notably through a platen press of the stamping machine, characterized in that it further comprises at least one first load-measurement device comprising a first detector configured to measure a parameter indicative of the load applied by the drive member for driving the foil-introduction chain-like elements in a first direction, the at least one first load-measurement device being connected to a stamping-machine control unit configured to stop the driving by the drive member when the parameter indicative of the load applied by the drive member and measured by the first detector crosses a threshold.

Driving may thus be stopped before there is a risk of the drive bar or its attachment breaking.

In order to detect possible malfunctioning in the two directions of driving of the foil-introduction chain-like elements, provision is made for example for the driving device to comprise a second load-measurement device comprising a second detector configured to measure a parameter indicative of the load applied by the drive member for driving the foil-introduction chain-like elements in a second direction, the opposite of the first direction, the second load-measurement device being connected to the control unit configured to stop the driving by the drive member when the parameter indicative of the load applied by the drive member and measured by the second detector crosses a threshold.

The driving device may comprise two pairs of lower intermediate transmission elements able to move vertically and aligned horizontally to guide each foil-introduction chain-like element in a horizontal straight line through the platen press. It is thus possible to retract the foil-introduction chain-like elements after the stamping foil has been introduced.

According to a first embodiment of the driving device, the first load-measurement device comprises:
a first mobile intermediate transmission element,
a first elastic member which urges the first intermediate transmission element against a foil-introduction chain-like element situated on one side of the drive member and pulled taut when the foil-introduction chain-like element is driven in the first direction, and
a first actuator configured to apply a counter-thrust to the first elastic member when the foil-introduction chain-like element is driven,
the first detector being configured to detect when the counter-thrust applied by the first actuator crosses a load threshold.

Where applicable, the second load-measurement device comprises for example:
a second mobile intermediate transmission element,
a second elastic member which urges the second intermediate transmission element against a foil-introduction chain-like element situated on one side of the drive member and pulled taut when the foil-introduction chain-like element is driven in the second direction, and
a second actuator configured to apply a counter-thrust to the second elastic member when the foil-introduction chain-like element is driven,
the second detector being configured to detect when the counter-thrust applied by the second actuator crosses a load threshold.

The first and/or the second load-measurement device may further comprise at least one additional intermediate transmission element for guiding the foil-introduction chain-like element through an angle of at least 90°.

The first and/or second intermediate transmission element may be interposed between the additional intermediate transmission element and the drive member on the path followed by the stamping foil.

According to a second embodiment of the driving device, the drive member is mounted with the ability to move in a direction of driving of the foil-introduction chain-like element, the first detector being configured to measure when a movement of the drive member indicative of the load applied by the drive member crosses a threshold.

The first load-measurement device comprises for example a first counter-thrust member, such as an actuator, configured to apply a counter-thrust to the drive member when the foil-introduction chain-like element is driven in the first direction, the first detector being configured to detect when the counter-thrust applied by the first counter-thrust member crosses a load threshold.

Where applicable, the second load-measurement device comprises for example a second counter-thrust member, such as an actuator, configured to apply a counter-thrust to the drive member when the foil-introduction chain-like element is driven in the second direction, the second detector being configured to detect when the counter-thrust applied by the second counter-thrust member crosses a load threshold.

The first and/or second load-measurement device comprises for example a linear guide on which the drive member is slidably mounted.

The drive member comprises for example a driveshaft coupled to the foil-introduction chain-like elements by a respective universal joint, making it possible to ensure independence of operation on each side of the machine (driver-side and opposite side).

Another subject of the invention is a stamping-foil feed and recovery station for a machine for stamping elements in sheet form, characterized in that this station comprises a stamping-foil driving device as described hereinabove.

A further subject of the invention is a machine for stamping elements in sheet form, characterized in that it comprises a plurality of workstations including a stamping-foil feed and recovery station as described hereinabove.

Another subject of the invention is a method for controlling the driving of a stamping foil, characterized in that it is implemented by means of a driving device as described hereinabove.

According to a first embodiment of the method for controlling the driving of a stamping foil:
when the foil-introduction chain-like element is driven in a first direction, a first actuator applies a counter-thrust to a first elastic member compression-loaded by the strand of the foil-introduction chain-like element that is pulled taut by the driving of the drive member, a second actuator being inactive,
when the foil-introduction chain-like element is driven in an opposite, second, direction, a second actuator applies a counter-thrust to a second elastic member compression-loaded by the strand of the foil-introduction chain-like element that is pulled taut by the driving of the drive member, the first actuator being inactive.

The activated actuators apply a counter-thrust to the elastic members for example in such a way as to keep the intermediate transmission elements in position.

According to a second embodiment of the method for controlling the driving of a stamping foil, the counter-thrust members apply a counter-thrust on each side of the drive member with respect to the direction of driving.

The counter-thrust members apply a counter-thrust to the drive member for example in such a way as to keep the drive member in position.

### BRIEF DESCRIPTION OF THE DRAWINGS

Other advantages and features will become apparent on reading the description of the invention, and also from the appended drawings which depict one nonlimiting exemplary embodiment of the invention and in which:

FIG. 1 very schematically illustrates one example of a stamping machine according to a first exemplary embodiment.

FIG. 2 is a perspective view of a driving device of the stamping-foil feed and recovery station of the machine of FIG. 1, with a drive bar positioned at a point of introduction of the stamping foil.

FIG. 3 is a driver-side view of elements of the driving device of FIG. 2.

FIG. 4 is a view in cross section of a detail of the driving device of FIG. 3.

FIG. 5a shows a first and a second load-measurement device of the driving device of FIG. 3, in a standby position.

FIG. 5b shows the load-measurement devices of FIG. 5a when the foil-introduction chain-like element is driven in a first direction, during normal operation.

FIG. 5c shows the load-measurement devices of FIG. 5b when the load applied by a drive member crosses a threshold.

FIG. 6 is a driver-side view of a driving device of the stamping-foil feed and recovery station according to a second exemplary embodiment, with a drive bar positioned at a point of introduction of the stamping foil.

FIG. 7 shows elements of FIG. 6 viewed from the inside of the machine.

In these figures, identical elements bear the same reference numbers. The following implementations are examples. Although the description refers to one or more embodiments, this does not necessarily mean that each reference relates to the same embodiment or that the features apply only to just one embodiment. Simple features of different embodiments can also be combined or interchanged to provide other embodiments.

The expression “sheet-form elements” is equally applicable to elements made of corrugated board, flat board, paper or any other material commonly used in the packaging industry. It should be understood that throughout this text, the terms “sheet” or “sheet element” or “sheet-form element” very generally refer to any printing support in the form of sheets, such as, for example, sheets of board, paper, plastic, etc.

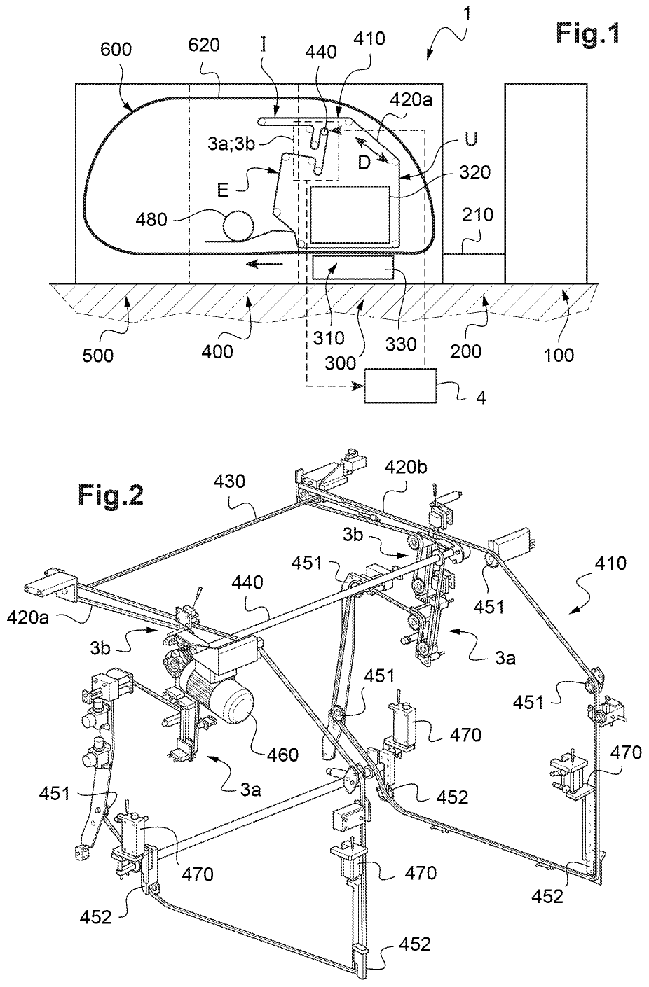

FIG. 1 depicts one exemplary embodiment of a sheet-form element stamping machine 1 capable of printing, by stamping, a succession of flat sheet-form elements, notably for the manufacture of packagings.

This machine 1 is conventionally made up of a number of workstations 100, 200, 300, 400, 500 which are juxtaposed but interdependent on one another to form a unit assembly capable of processing a succession of sheet-form elements. Thus, there is a feeder 100, a feeder table 200, a stamping station 300, a stamping-foil feed and recovery station 400, and an delivery station 500. A transport device 600 is also provided for moving each sheet individually from the exit of the feeder table 200 to the delivery station 500, including through the stamping station 300.

In this particular embodiment, which has been chosen solely by way of example, the feeder 100 is stocked by means of a succession of pallets on each of which a plurality of sheets of board are stacked. The latter are removed in succession from the top of the pile by a suction type gripper member which transports them to the immediately-adjacent feeder table 200.

At the feeder table 200, the sheets are laid out in a layer by the suction-type gripper member, which means to say are laid out one after the other in such a way that they partially overlap. The entire layer is then driven along a plate 210 towards the stamping station 300 by means of a belt-type conveying mechanism. At the end of the layer, the lead sheet may be systematically positioned accurately using frontal and lateral lay guides or using a register system.

The workstation situated just after the feeder table 200 is therefore the stamping station 300. The purpose of the latter is to apply to each sheet, by hot stamping, metallized film that comes from a stamping foil. In order to do that, it uses a platen press 310 within which the stamping operation takes place in the conventional way, between a fixed, heated, upper platen 320 and a lower platen 330 which is mounted with the ability to move in a reciprocating vertical movement.

The foil feed and recovery station 400 has the task both of feeding the machine with stamping foil and of removing this same foil once it has become used, downstream of the stamping station 300.

The process of processing the sheets in the printing machine 1 is completed in the delivery station 500, the main purpose of which is to re-stack the previously-processed sheets into a pile. In order to do that, the transport device 600 is for example arranged in such a way as to automatically release each sheet when the latter is in line with this new pile. The sheet then drops squarely onto the top of the pile.

In a very conventional way, the transport device 600 employees a series of gripper bars which are mounted with the ability to move via two chainsets 620 arranged laterally on each side of the stamping machine 1. Each chainset 620 runs in a loop which allows the gripper bars to follow a path that passes in succession through the stamping station 300, the stamping-foil feed and recovery station 400 and the delivery station 500.

Prior to production, the stamping foil is introduced between the platens 320, 330 of the press 310 by a driving device 410 belonging to the foil feed and recovery station 400 and which is capable of conveying it along a determined path.

As is better visible in the example of FIG. 2, the driving device 410 comprises two foil-introduction chain-like elements 420a, 420b and a drive member 440 coupled to the chain-like elements 420a, 420b for driving the chain-like elements 420a, 420b. There are two foil-introduction chain-like elements 420a, 420b which are arranged laterally in the machine 1, on the one hand on a “driver-side” situated on the side of the operator and, on the other hand, on an “opposite side”, situated on the other side of the stamping machine 1.

The foil-introduction chain-like elements 420a, 420b are, for example, chains (or high-temperature-resistant belts) which are closed on themselves in a loop. The drive member 440 comprises for example a transverse driveshaft coupled to the foil-introduction chain-like elements 420a, 420b for example via guides or sprocket wheels or pulleys. The drive member 440 is for example set in motion by a motor 460 of the station 400.

A drive bar 430 arranged transversely with respect to the direction of driving D is connected at its ends to the foil-introduction chain-like elements 420a, 420b to drive the stamping foil for example by winding the foil around the drive bar 430 over 180°.

According to one exemplary embodiment, each foil-introduction chain-like element 420a, 420b travels in a loop which allows the stamping foil to be unwound over a path passing between an upper point of introduction I (or an intermediate point U), and a lower recovery point E (FIG. 1), making, for example, a circuit of the upper platen 320 of the platen press 310, and passing through the platen press 310.

The drive member 440 may be able to drive the foil-introduction chain-like elements 420 in a first direction and in an opposite second direction: the forward direction and the back direction here defined with reference to the forward direction followed by the stamping foil along its path extending for example from the point of introduction I (or the intermediate point U) towards the recovery point E, passing through the platen press 310.

Thus, in an initial introduction phase, the operator winds the stamping foil around the drive bar 430 by hand. The bar 430 is then made to move in a first direction (or forward direction) over the path passing through the stamping station 300 between the platens of the press 310. The bar 430 then pulls along behind it the two strands of the stamping foil, one strand being pulled taut while the other is unwinding in the machine 1. Then at the exit from the press, the operator removes the free end unwound from the bar 430 to introduce it by hand into a driving roll 480 of the station 400 (FIG. 1). There are, for example, one or several driving rolls 480, each for example advancing the stamping foil by a particular step length.

Once the stamping foil has been unwound, the drive bar 430 can be driven in the opposite direction along the path from the recovery point E towards the point of introduction I (or intermediate point U). The drive bar 430 is, for example, returned to the point of introduction I before the end of introduction of the foil, or the bar can be left at the recovery point E and returned to the point of introduction I when the operator wishes to introduce a new stamping foil with which to feed the machine 1.

After this manual intervention, the drive roll 480 controls the advance of the at least one stamping foil so that the latter coincides with the sheet-form elements introduced elsewhere (not necessarily at the same pace) into the platen press 310 by the gripper bars of the conveying device 600.

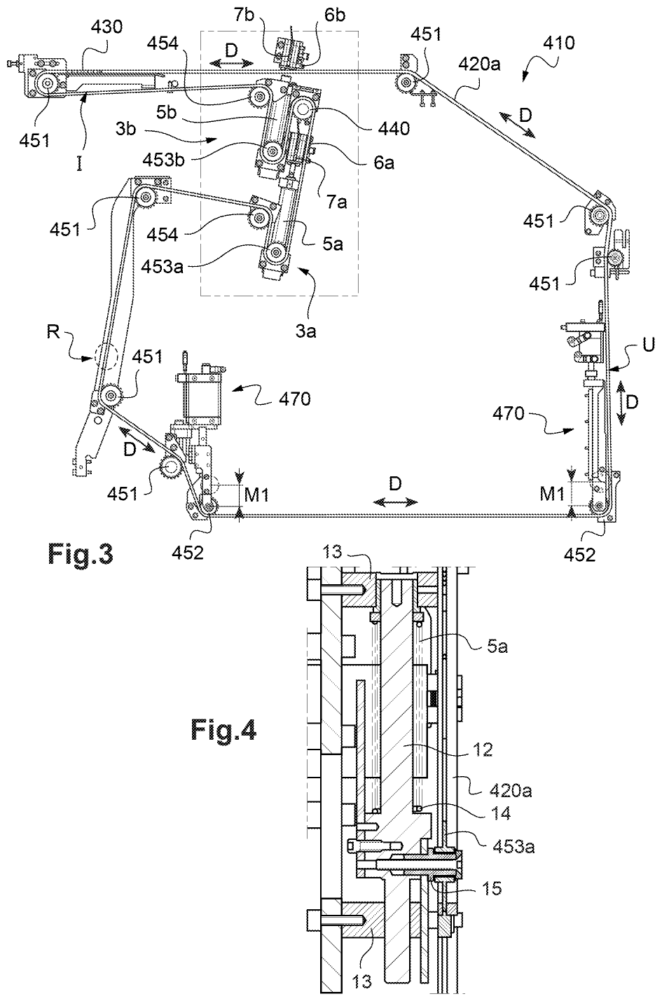

The driving device 410 further comprises for example a series of intermediate transmission elements 451, 452, such as wheels 451, 452 or skids, which are installed along the path to guide the foil-introduction chain-like elements 420a, 420b and thus the movement of the stamping foil (FIG. 3). The driving device 410 comprises for example notably two pairs of lower intermediate transmission elements 452, such as wheels, able to move vertically (over the distance M1) and aligned horizontally to guide each foil-introduction chain-like element 420a, 420b in a horizontal straight line through the platen press 310. Each mobile intermediate transmission element 452 is for example moved by means of its own controllable actuator 470 such as a ram. It is thus possible to make the drive bar 430 pass between the platens 320, 330 of the press 310 in order to introduce the stamping foils, and then retract the foil-introduction chain-like elements 420a, 420b before production, by raising the intermediate transmission elements 452 for example.

The driving device 410 further comprises at least one first load-measurement device 3a comprising a first detector 7a configured to measure a parameter indicative of the load applied by the drive member 440 for driving the foil-introduction chain-like elements 420a, 420b in a first direction. The at least one first load-measurement device 3a is connected to a control unit 4 of the stamping machine 1 (FIG. 1) configured to stop the driving by the drive member 440 when the parameter indicative of the load applied by the drive member 440 and measured by the first detector 7a crosses a threshold, such as a load greater than 100N or 150N for example.

The control unit 4 is for example a computer of the stamping machine 1.

It is possible to provide just one load-measurement device 3a or 3b per chain-like element 420a, 420b. However, given that the drive member 440 may drive the foil-introduction chain-like elements 420a, 420b in both directions, the driving device 410 may comprise a second load-measurement device 3b for measuring load applied in the second (for example back) direction.

The second load-measurement device 3b thus comprises a second detector 7b configured to measure a parameter indicative of the load applied by the drive member 440 for driving the foil-introduction chain-like elements 420a, 420b in the second direction, the second load-measurement device 3b being connected to the control unit 4 configured to stop the driving by the drive member 440 when the parameter indicative of the load applied by the drive member 440 and measured by the second detector 7b crosses a threshold.

Provision is made for example for the driving device 410 to comprise two pairs of load-measurement devices 3a, 3b, one pair of load-measurement devices 3a, 3b being arranged on a respective foil-introduction chain-like element 420a, 420b so as to detect an overload on each of the foil-introduction chain-like elements 420a, 420b.

In the first exemplary embodiment, the first measurement device 3a further comprises a first mobile intermediate transmission element 453a, a first elastic member 5a and a first actuator 6a (FIG. 3).

A first end of the first elastic member 5a urges the first intermediate transmission element 453a against one strand of a foil-introduction chain-like element 420a, 420b situated on one side of the drive member 440 and pulled taut when the foil-introduction chain-like element 420a, 420b is driven in the first direction along the path of the stamping foil.

The first actuator 6a is configured to apply a counter-thrust to a second end of the first elastic member 5a when the foil-introduction chain-like element 420a, 420b is driven, for example so as to keep the first mobile intermediate transmission element 453a in position.

The first detector 7a is configured to detect when the counter-thrust applied by the first actuator 6a crosses a load threshold.

Likewise, the second measurement device 3b comprises for example a second mobile intermediate transmission element 453b, a second elastic member 5b, a second actuator 6b and a second detector 7b.

A first end of the second elastic member 5b urges the second intermediate transmission element 453b against one strand of the foil-introduction chain-like element 420a, 420b situated on one side of the drive member 440 and pulled taut when the foil-introduction chain-like element (420a, 420b) is driven in the second direction. There is therefore one elastic-member/intermediate-transmission-element assembly on each side of the drive member 440.

The second actuator 6b is configured to apply a counter-thrust to a second end of the second elastic member 5b when the foil-introduction chain-like element 420a, 420b is driven, for example so as to keep the second mobile intermediate transmission element 453b in position.

The second detector 7b is configured to detect when the counter-thrust applied by the second actuator 6b crosses a load threshold.

The mobile intermediate transmission elements 453a, 453b are for example guides, pulleys, sprocket wheels or skids.

The actuators 6a, 6b are for example rams, such as pneumatic rams.

The detectors 7a, 7b are for example proximity sensors, namely contactless sensors, such as magnetic sensors. They may be incorporated into a respective actuator 6a, 6b. The detectors 7a, 7b for example send an electrical signal back to the control unit 4 when the measured parameter indicative of the load applied by the drive member 440 crosses a threshold.

The elastic members 5a, 5b comprise for example compression springs.

According to one exemplary embodiment best visible in FIG. 4, the elastic member 5a, 5b comprises a compression spring surrounding a guide 12 slidably mounted between two bearings 13. A first end 14 of the spring 5a bears against the guide 12, the guide 12 being fixed (in this instance at right angles) to the pivot 15 of the intermediate transmission element 453a, 453b. The movement of the intermediate transmission element 453a, 453b is therefore as one with the movement of the guide 12, the guide 12 moving with the load applied to the second end of the spring.

The axes of the elastic members 5a, 5b are for example perpendicular to the direction of driving D of the foil-introduction chain-like elements 420a, 420b.

The load-measurement devices 3a, 3b further comprise, for example, at least one respective additional intermediate transmission element 454, such as a guide, pulley, sprocket wheel or skid, to guide the foil-introduction chain-like element 420a, 420b over an angle of at least 90°, such as 180° (FIG. 3) . The intermediate transmission element 453a, 453b is for example formed of a wheel situated in the belly of a loop of the foil-introduction chain-like element 420a, 420b, for example interposed between the additional intermediate transmission element 454 and the drive member 440 on the path followed by the stamping foil.

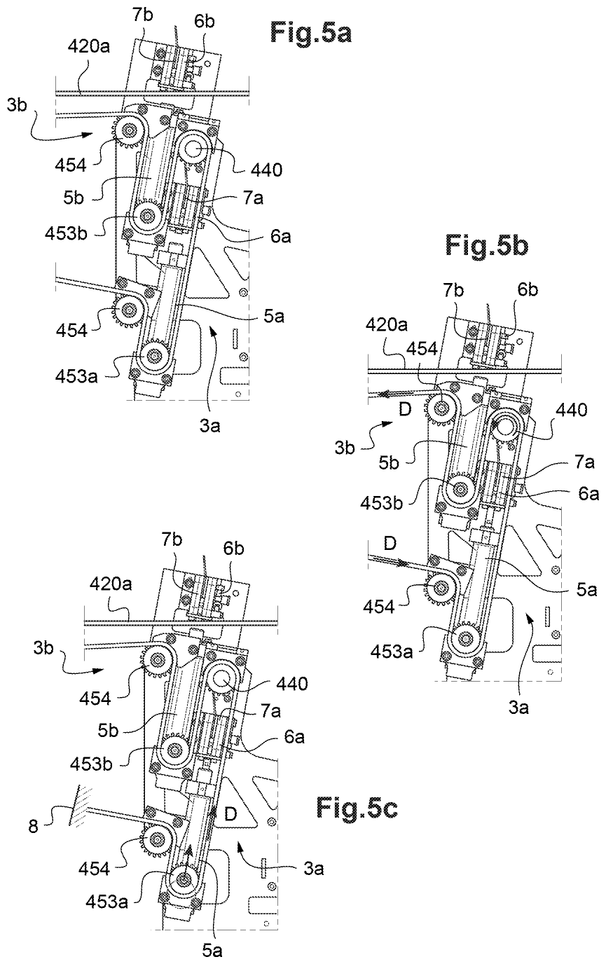

One example of the operation of a method for controlling the driving of a stamping foil by means of the driving device 410 will now be described with reference to FIGS. 5a, 5b and 5c.

In FIG. 5a, the load-measurement devices 3a, 3b are initially in a standby position. The motor 460 and the actuators 6a, 6b are stationary, the drive member 440 is immobilized. The operator adjusts the heightwise position of the mobile intermediate transmission elements 452 in order to position the foil-introduction chain-like elements 420a, 420b at the height of the platen press 310 (FIG. 3). As a result of this, the mobile intermediate transmission elements 453a, 453b of the load-measurement devices 3a, 3b move against the action of the elastic members 5a, 5b. A minimal tension is exerted between the elastic members 5a, 5b and the foil-introduction chain-like elements 420a, 420b.

The first actuator 6a is activated. It applies a counter-thrust to the first elastic member 5a thus compression-loaded by the strand of the foil-introduction chain-like element 420a, 420b that is pulled taut by the driving of the drive member 440, for example so as to keep the first mobile intermediate transmission element 453a in position. The ram rod of the first actuator 6a extends for example until it presses against the second end of the first elastic member 5a. The first intermediate transmission element 453a is kept in position.

After the motor 460 has started, the drive member 440 may drive the foil-introduction chain-like elements 420a, 420b in a first direction (or forward direction, arrow D, FIG. 5b).

On the other side of the drive member 440, the second actuator 6b is inactive. The tension in the strand of the foil-introduction chain-like element 420a is determined by the second elastic element 5b. The ram rod of the second actuator 6b is retracted (FIG. 5b).

Should anything 8 happen to block the advance of the foil-introduction chain-like elements 420a, 420b, the counter-thrust applied by the first actuator 6a will no longer be enough to keep the first mobile intermediate transmission element 453a in position and it will move (in this instance upwards, FIG. 5c) and the travel of the first actuator 6a reduces. These elements for example allow the first detector 7a to detect that the counter-thrust applied by the first actuator 6a is crossing a load threshold. The control unit 4 then stops the driving by the drive member 440 for example by cutting the supply of power to the motor 460.

Driving may thus be stopped before there is a risk of the drive bar 430 or its attachment breaking.

In normal operation, the drive member 440 may also drive the foil-introduction chain-like elements 420a, 420b in the opposite second direction (or back direction) (for example by turning anticlockwise).

The second actuator 6b is then activated. It applies a counter-thrust to the second elastic member 5b thus compression-loaded by the strand of the foil-introduction chain-like element 420a, 420b that is pulled taut by the driving of the drive member 440, for example so as to keep the second mobile intermediate transmission element 453b in position. The ram rod of the second actuator 6b extends for example until it presses against the second end of the second elastic member 5b. The second intermediate transmission element 453b is kept in position.

On the other side of the drive member 440, the first actuator 6a is inactive. The tension in the strand of the foil-introduction chain-like element 420a is determined by the first elastic element 5a. The ram rod of the first actuator 6a is retracted.

Should anything 8 happen to block the advance of the foil-introduction chain-like elements 420a, 420b, the counter-thrust applied by the second actuator 6b will no longer be enough to keep the second mobile intermediate transmission element 453b in position and it will move (in this instance upwards) and the travel of the second actuator 6b reduces. These elements for example allow the second detector 7b to detect that the counter-thrust applied by the second actuator 6b is crossing a load threshold. The control unit 4 then stops the driving by the drive member 440 for example by cutting the supply of power to the motor 460.

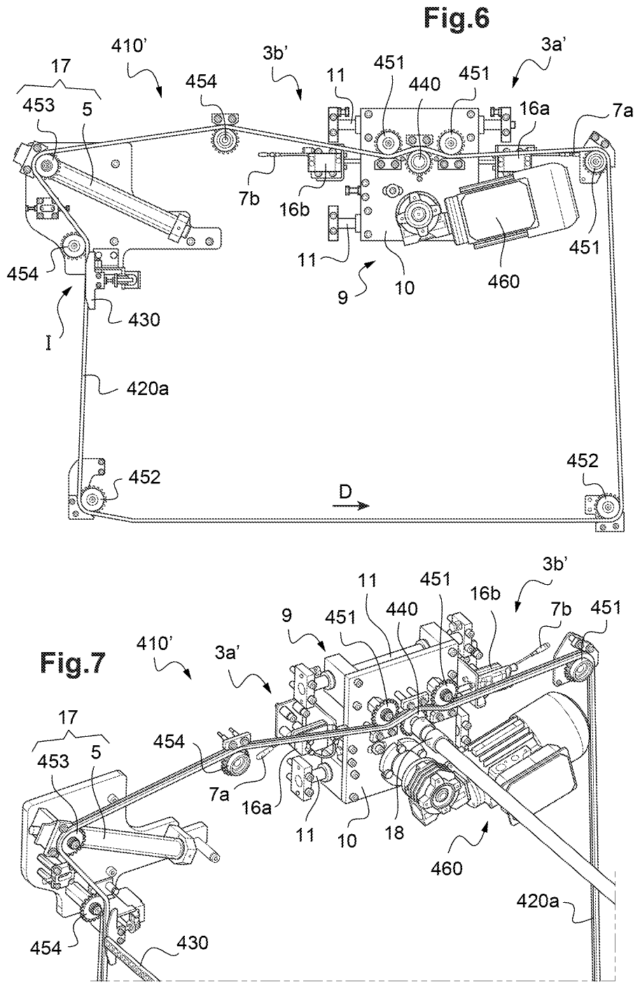

FIGS. 6 and 7 illustrate a second exemplary embodiment of the driving device 410′.

As previously, the driving device 410′ comprises a first load-measurement device 3a′ comprising a first detector 7a configured to measure a parameter indicative of the load applied by the drive member 440 for driving the foil-introduction chain-like elements 420a, 420b in a first direction. The first load-measurement device 3a′ is connected to the control unit 4 of the stamping machine 1 (FIG. 1) configured to stop the driving by the drive member 440 when the parameter indicative of the load applied by the drive member 440 and measured by the first detector 7a crosses a threshold.

This second embodiment differs from the previous one in that the load-measurement device does not apply any counter-load against the foil-introduction chain-like elements 420a, 420b′. In this second embodiment, the drive member 440 is mounted with the ability to move in a direction of driving D of the foil-introduction chain-like elements 420a, 420b.

For that, the first load-measurement device 3a′ comprises for example a linear guide 9 on which the drive member 440 is slidably mounted. The linear guide 9 for example allows the drive member 440 to move horizontally in an upper zone of the foil-introduction chain-like elements 420a, 420b. The linear guide 9 for example comprises a mobile support 10, such as a plate, sliding along at least one fixed horizontal spindle 11, such as two spindles 11 arranged one above the other.

Furthermore, in this embodiment, the first detector 7a is configured to measure when a movement of the drive member 440 indicative of the load applied by the drive member 440 crosses a threshold.

The drive member 440 comprises for example a transverse driveshaft coupled to the foil-introduction chain-like elements 420a, 420b. The drive member 440 is for example set in motion by a motor 460 of the station 400, to which motor it is connected for example by means of a transmission device which has not been depicted.

In order to guarantee independent operation of the mobile supports 10 on each side of the machine 1 (on the driver side and on the opposite side) and prevent these from jamming if one of the two foil-introduction chain-like elements 420a, 420b becomes jammed, these may be connected to the foil-introduction chain-like elements 420a, 420b by a respective universal joint 18 (FIG. 7).

The drive member 440 may be able to drive the foil-introduction chain-like elements 420a, 420b in just one (forward) direction or in both directions (forwards and back). The drive bar 430 is for example driven over a full circuit of the path. It returns to the point of introduction I after having passed through the platen press 310. Backwards driving may be used notably if a problem with the driving of the stamping foil occurs.

The first load-measurement device 3a′ comprises for example a first counter-thrust member 16a configured to apply a counter-thrust to the drive member 440 when the foil-introduction chain-like element 420a, 420b is driven in a first direction. The first counter-thrust member 16a is for example an actuator or an elastic member. The actuator is for example a ram, such as a pneumatic ram. The counter-thrust is for example applied to the mobile support 10 fixed to the drive member 440.

The first detector 7a is for example configured to detect when the counter-thrust applied by the first counter-thrust member 16a crosses a load threshold.

When the drive member 440 is able to drive the foil-introduction chain-like elements 420 in both directions (forwards and back), the driving device 410′ may comprise a second load-measurement device 3b′ for measuring load in the second direction.

The second load-measurement device 3b′ comprises for example a second counter-thrust member 16b configured to apply a counter-thrust to the drive member 440 when the foil-introduction chain-like element 420a, 420b is driven in the second direction. The second counter-thrust member 16b is for example an actuator or an elastic member. The actuator is for example a ram, such as a pneumatic ram. The counter-thrust is for example applied to the mobile support 10 fixed to the drive member 440.

The second detector 7b is for example configured to detect when the counter-thrust applied by the second counter-thrust member 16b crosses a load threshold.

The counter-thrust members 16a, 16b apply a counter-thrust on each side of the support 10 with respect to the direction of driving D. The counter-thrusts applied allow for example the support 10 to be kept in position. The counter-thrust in normal operation is for example nil, such that the rods of the actuators are fully extended and simply touch the support 10.

The driving device 410′ comprises for example two pairs of load-measurement devices 3a′, 3b′, one pair being arranged on a respective foil-introduction chain-like element 420a, 420b so as to detect an overload on each of the chain-like elements 420a, 420b.

As in the first embodiment, the detectors 7a, 7b are for example proximity sensors, namely contactless sensors, such as magnetic sensors. They may be incorporated into a respective actuator. The detectors 7a, 7b for example send an electrical signal back to the control unit 4 when the measured parameter indicative of the load applied by the drive member 440 crosses a threshold.

The detectors 7a, 7b may also be produced in the form of any type of movement detector, such as a contact-type sensor.

The driving device 410′ may further comprise at least one conventional chain tensioner 17 comprising a mobile intermediate transmission element 453 and an elastic member 5.

One example of the operation of a method for controlling the driving of a stamping foil by means of a driving device 410′ will now be described with reference to FIGS. 6 and 7.

The load-measurement devices 3a′, 3b′ are initially in a standby position. The motor 460 is stationary, the drive member 440 is immobilized. The operator adjusts the heightwise position of the mobile intermediate transmission elements 452 in order to position the foil-introduction chain-like elements 420a, 420b at the height of the platen press 310. As a result of this, the mobile intermediate transmission elements 453 move against the action of the elastic members 5. A minimal tension is exerted between the elastic members 5 and the foil-introduction chain-like elements 420a, 420b.

After the motor 460 has started, the drive member 440 may drive the foil-introduction chain-like elements 420a, 420b in a first direction (or forward direction, arrow D, FIG. 6, or anticlockwise direction in FIG. 6).

The counter-thrust members 16a, 16b apply a counter-thrust on each side of the drive member 440 with respect to the direction of driving D. For example, the rods of the actuators are fully extended and simply touch the support 10 on each side.

Should anything happen to block the advance of the foil-introduction chain-like elements 420a, 420b, the counter-thrust applied by the first counter-thrust member 16a will no longer be enough to keep the mobile support 10 in position and it will move (in this instance to the right with respect to the orientation of FIG. 6). The travel of the first counter-thrust member 16a decreases for example down to a minimum. These elements for example allow the first detector 7a to detect that the counter-thrust applied by the first counter-thrust member 16a is crossing a load threshold. The control unit 4 then stops the driving by the drive member 440 for example by cutting the supply of power to the motor 460. Driving may thus be stopped before there is a risk of the drive bar 430 or its attachment breaking.

In normal operation, the drive member 440 may also drive the foil-introduction chain-like elements 420a, 420b in the opposite second direction (or back direction) (for example by turning clockwise).

Should anything happen to block the advance of the foil-introduction chain-like elements 420a, 420b, the counter-thrust applied by the second counter-thrust member 16b will no longer be enough to keep the mobile support 10 in position and it will move (in this instance to the left) and the travel of the second counter-thrust member 16b reduces. These elements for example allow the second detector 7b to detect that the counter-thrust applied by the second counter-thrust member 16b is crossing a load threshold. The control unit 4 then stops the driving by the drive member 440 for example by cutting the supply of power to the motor 460.

1. A driving device for driving a stamping foil over a path, the driving device comprising:
two foil-introduction chain-like elements; and
a drive member coupled to the two foil-introduction chain-like elements for driving the two foil-introduction chain-like elements notably through a platen press of the stamping machine, wherein the driving device further comprises at least one first load-measurement device, the at least one first load-measurement device including a first detector configured to measure a parameter indicative of a load applied by the drive member for driving the two foil-introduction chain-like elements in a first direction, the at least one first load-measurement device being connected to a control unit of the stamping-machine configured to stop the driving by the drive member when the parameter indicative of the load applied by the drive member and measured by the first detector crosses a threshold.

2. The driving device of claim 1, further including a second load-measurement device, the a second load-measurement device including a second detector configured to measure a second parameter indicative of the load applied by the drive member for driving the two foil-introduction chain-like elements in a second direction, the second direction being in an opposite direction of the first direction, the second load-measurement device being connected to the control unit configured to stop the driving by the drive member when the second parameter indicative of the load applied by the drive member and measured by the second detector crosses a second threshold.

3. The driving device of claim 1, wherein the first load-measurement device includes:
a first mobile intermediate transmission element,
a first elastic member that urges the first intermediate transmission element against a foil-introduction chain-like element situated on one side of the drive member and pulled taut when the foil-introduction chain-like element is driven in the first direction, and
a first actuator configured to apply a counter-thrust to the first elastic member when the foil-introduction chain-like element is driven,
the first detector being configured to detect when the counter-thrust applied by the first actuator crosses a load threshold.

4. The driving device of claim 3, wherein the second load-measurement device includes:
a second mobile intermediate transmission element,
a second elastic member that urges the second intermediate transmission element against a foil-introduction chain-like element situated on one side of the drive member and pulled taut when the foil-introduction chain-like element is driven in the second direction, and
a second actuator configured to apply a counter-thrust to the second elastic member when the foil-introduction chain-like element is driven,
the second detector being configured to detect when the counter-thrust applied by the second actuator crosses a load threshold.

5. The driving device of claim 4, wherein the first load-measurement device and/or the second load-measurement device further includes at least one additional intermediate transmission element for guiding the foil-introduction chain-like element through an angle of at least 90°.

6. The driving device of claim 4, wherein the first mobile intermediate transmission element and/or second mobile intermediate transmission is interposed between the additional intermediate transmission element and the drive member on the path followed by the stamping foil.

7. The driving device of claim 1, wherein the drive member is mounted with the ability to move in a direction of driving of the two foil-introduction chain-like element, the first detector being configured to measure when a movement of the drive member indicative of the load applied by the drive member crosses a threshold.

8. The driving device of claim 1, wherein the first load-measurement device comprises a first counter-thrust member, configured to apply a counter-thrust to the drive member when the two foil-introduction chain-like element are driven in the first direction, the first detector being configured to detect when the counter-thrust applied by the first counter-thrust member crosses a load threshold.

9. The driving device of claim 2, wherein the second load-measurement device comprises a second counter-thrust member configured to apply a counter-thrust to the drive member when the two foil-introduction chain-like element are driven in the second direction, the second detector being configured to detect when the counter-thrust applied by the second counter-thrust member crosses a load threshold.

10. The driving device of claim 7, wherein the first load-measurement device and/or the second load-measurement device further includes a linear guide on which the drive member is slidably mounted.

11. The driving device of claim 7, wherein the drive member comprises a driveshaft coupled to the two foil-introduction chain-like elements by a respective universal joint.

12. The driving device of claim 7, further including two pairs of lower intermediate transmission elements able to move vertically and aligned horizontally to guide each of the two foil-introduction chain-like elements in a horizontal straight line through the platen press.

13. A stamping-foil feed and recovery station for stamping elements in sheet form, wherein the stamping-foil feed and recovery station includes the driving device according to claim 1.

14. A machine for stamping elements in sheet form, wherein the machine includes a plurality of workstations including the stamping-foil feed and recovery station according to claim 13.

15. A method for controlling driving of a stamping foil, wherein the method is implemented by means of the driving device according to claim 1.

16. A method for controlling driving of a stamping foil, wherein the method is implemented by means of the driving device according to claim 4, in which
when the foil-introduction chain-like element is driven in the first direction, the first actuator applies a counter-thrust to the first elastic member compression-loaded by a strand of the foil-introduction chain-like element that is pulled taut by the driving of the drive member, the second actuator (being inactive, and
when the foil-introduction chain-like element is driven in the second direction, the second actuator applies a counter-thrust to the second elastic member compression-loaded by a strand of the foil-introduction chain-like element that is pulled taut by the driving of the drive member, the first actuator being inactive.

17. The method according to claim 16, wherein the activated first actuator and the second actuator apply the counter-thrust to the first elastic member and the second elastic member in such a way as to keep the intermediate transmission elements in position.

18. A method for controlling driving of a stamping foil, wherein the method is implemented by means of the driving device according to claim 9, wherein the counter-thrust members apply a counter-thrust on each side of the drive member with respect to a direction of driving.

19. The method according to claim 18, wherein the counter-thrust members apply the counter-thrust to the drive member in such a way as to keep the drive member in position.
